(19) United States
(12) Patent Application Publication
(10) Pub. No.: US 2015/0370494 A1
(43) Pub. Date: Dec. 24, 2015

(54) REDUNDANT STORAGE SYSTEM

(71) Applicant: Tianjin Surdoc Corp., Tianjin (CN)

(72) Inventor: Donglin WANG, Tianjin (CN)

(21) Appl. No.: 14/739,996

(22) Filed: Jun. 15, 2015

(30) Foreign Application Priority Data
Jun. 19, 2014 (CN) 201420330766.1

(51) Int. Cl. G06F 3/06; G06F 13/40

(52) U.S. Cl. CPC G06F 3/0619; G06F 3/065; G06F 3/0689; G06F 13/4068

(57) ABSTRACT

A redundant storage system which can automatically recover RAID data by crossing different JBODs includes: at least one server, at least one SAS switch, and at least two storage devices; each of the at least one server includes an interface card, and each of the at least one server is connected to the at least one SAS switch through a SAS port of the interface card; each of the at least two storage devices is connected to the at least one SAS switch through a SAS interface; each of the at least two storage devices includes at least one physical disk; physical disks respectively included in different storage devices constitute a RAID group.

### CROSS-REFERENCE TO RELATED APPLICATION

This application claims priority of Chinese Patent Application Serial No. 201420330766.1, filed on Jun. 19, 2014, the entire contents of which are incorporated herein by reference for all purposes.

### FIELD OF THE INVENTION

The present invention is related to internet technology, and more particularly to a redundant storage system.

### BACKGROUND OF THE INVENTION

FIG. 1 illustrates a structure of a RAID (Redundant Arrays of Independent Disks) storage system provided by the prior art. As shown in FIG. 1, in the prior art of RAID storage, a RAID card is installed in a server, and the server is connected to a JBOD (Just a Bunch of Disks) through a SAS (Serial Attached SCSI) line. The JBOD may include multiple physical disks, such as 8, 5 or 4 physical disks. The multiple physical disks in the JBOD constitute a RAID group. In this case, once a physical disk is corrupt, data can be recovered through RAID mechanism.

However, once a JBOD is corrupt, date cannot be automatically recovered through RAID mechanism.

### SUMMARY OF THE INVENTION

A redundant storage system is provided by an embodiment of the present invention, which can automatically recover RAID data by a RAID group crossing different JBODs.

In an embodiment of the present invention, a redundant storage system provided includes:

at least one server, at least one SAS switch, and at least two storage devices;

wherein each of the at least one server includes an interface card; each of the at least one server is connected to the at least one SAS switch through a SAS port of the interface card; each of the at least two storage devices is connected to the at least one SAS switch through a SAS interface; each of the at least two storage devices includes at least one physical disk;

physical disks respectively included in different storage devices constitute a RAID group.

In a redundant storage system provided by an embodiment of the present invention, a SAS switch is included, so that a RAID group including multiple physical disks can be constructed crossing different storage devices. Furthermore, comparing with using one storage device as a storage expansion unit in the prior art, one RAID group is used as a storage expansion unit in the present invention, which can make the system more flexible and more applicable for a Big data system.

### BRIEF DESCRIPTION OF THE DRAWINGS

FIG. 1 illustrates structure of a RAID storage system in the prior art.

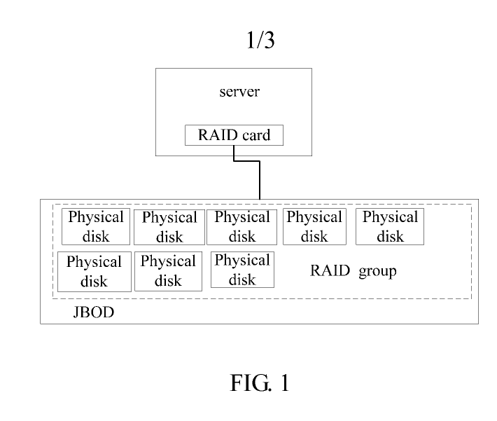

FIG. 2 illustrates structure of a redundant storage system according to an embodiment of the present invention.

FIG. 3 illustrates structure of a redundant storage system according to another embodiment of the present invention.

### DETAILED DESCRIPTION OF THE INVENTION

To give a further description of the embodiments in the present invention, the appended drawings used to describe the embodiments will be introduced as follows. Obviously, the appended drawings described here are only used to explain some embodiments of the present invention. Those skilled in the art can understand that other appended drawings may be obtained according to these appended drawings without creative work.

According to an embodiment of the present invention, a redundant storage system includes: at least one server, at least one SAS switch, and at least two storage devices. Each of the at least one server includes an interface card; each of the at least one server is connected to the at least one SAS switch through a SAS port of the interface card; each of the at least two storage devices is connected to the at least one SAS switch through a SAS interface; each of the at least two storage devices includes at least one physical disk; physical disks respectively included in different storage devices constitute a RAID group.

In an embodiment of the present invention, the physical disk may be any storage medium, such as hard disk, or SSD disk, etc.

In an embodiment of the present invention, the interface card may be a RAID card or a HBA (Host Bus Adapter) card, etc. In the description of the following embodiments, the RAID card is taken as an example of the interface card to illustrate the present invention.

In an embodiment of the present invention, the storage device may be JBOD. In the description of the following embodiments, JBOD is taken as an example of the storage device to illustrate the present invention.

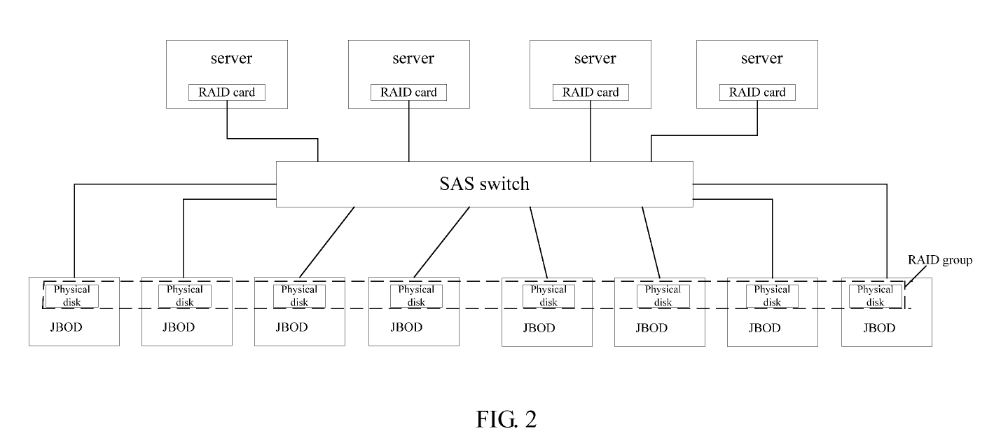

FIG. 2 illustrates structure of a redundant storage system according to an embodiment of the present invention. As shown in FIG. 2, the redundant storage system includes: at least one server (4 servers are shown in FIG. 2 as an example), one SAS switch, and at least two JBODs (8 JBODs are shown in FIG. 2 as an example).

As shown in FIG. 2, a RAID card is installed in each server, and each server is connected to the SAS switch through a SAS port of the RAID card.

Each JBOD includes at least one physical disk. Each JBOD is connected to the SAS switch through a SAS interface.

Multiple physical disks included in different JBODs constitute a RAID group. As shown in FIG. 2, Each RAID group may be constituted by 8 physical disks respectively included in 8 JBODs. The RAID group, which is constituted by physical disks crossing different JBODs, can be controlled by the RAID card of any server.

In this structure, the physical disks constituting the RAID group are respectively included in different storage devices, so no matter which physical disk or storage device is corrupt, the redundant storage system can keep normal working due to the RAID mechanism.

Furthermore, no matter which server is failed, any of the other servers can manage the RAID group managed by the failed server.

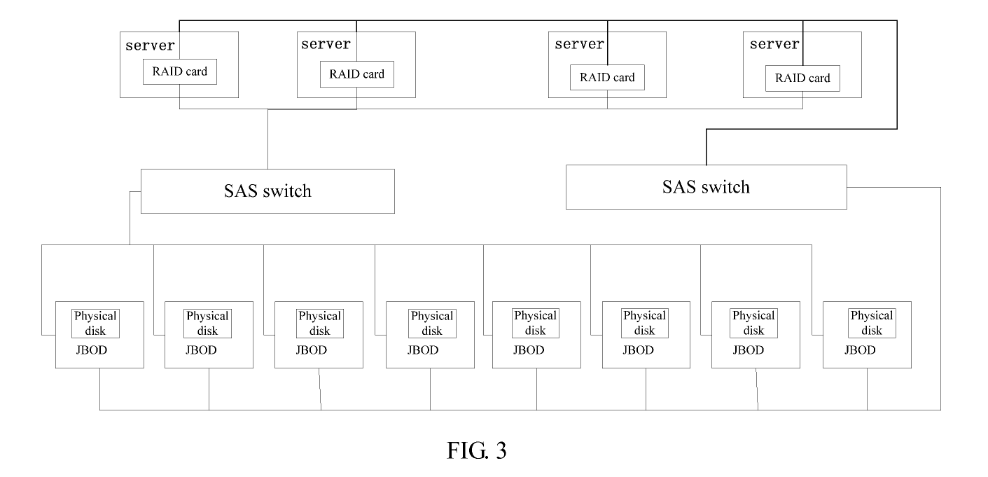

FIG. 3 illustrates structure of a redundant storage system according to another embodiment of the present invention. As shown in FIG. 3, the redundant storage system in FIG. 3, different from the system illustrated in FIG. 2, includes at least two SAS switches.

In this case, the RAID card installed in each server has at least two SAS ports, and the at least two SAS ports are respectively used to be connected with the at least two SAS switches.

In this case, no matter which SAS switch is failed, the connections between the servers and the JBODs can be accomplished by the other SAS switches.

When the technical scheme provided by embodiments of the present invention is applied to a Big data system, storage devices with large capacity (at least two storage devices) should be chosen before building the system. In the initial application, each storage device may not include a lot of physical disks. Each storage device may be expanded by using a RAID group as a storage expansion unit; that is to say, during one time of storage expansion, physical disks of a RAID group are respectively added to each storage device at the same time. However, in the prior art, one storage device is used as a storage expansion unit; which means, only when a storage device has been full filled with physical disks, another storage device can be added into the system.

Moreover, it should be understood that although this literature is described in embodiments, however, not each embodiment has merely one independent technical scheme. This way of description is used barely for clarity. For those skilled in the art, this literature should be considered as an entirety. Technical schemes from each embodiment could be properly combined and form as other embodiments that can be understood by those skilled in the art.

1. A redundant storage system, comprising:
at least one server, at least one SAS switch, and at least two storage devices;
wherein each of the at least one server comprises an interface card; each of the at least one server is connected to the at least one SAS switch through a SAS port of the interface card; each of the at least two storage devices is connected to the at least one SAS switch through a SAS interface; each of the at least two storage devices comprises at least one physical disk; physical disks respectively included in different storage devices constitute a RAID group.

2. The system of claim 1, wherein the at least one SAS switch comprises 2 SAS switches; each interface card comprises 2 SAS ports.

3. The system of claim 1, wherein the at least one server comprises 4 servers; the at least two storage devices comprise 8 storage devices;
wherein the RAID group is constituted of 8 physical disks respectively included in different 8 storage devices.

4. The system of claim 1, wherein the at least two storage devices are JBODs.

5. The system of claim 1, wherein the interface card is a RAID card or a HBA card.
